(19) United States
(12) Patent Application Publication
(10) Pub. No.: US 2005/0044335 A1
(43) Pub. Date: Feb. 24, 2005

(54) Master slave arrangement

(76) Inventors: Graham Michael Bee, Woodbridge (GB); Alan Andrew Goode, Ipswich (GB); Ian Mitchell, Ipswich (GB); Christian Rookes, Ipswich (GB)

Correspondence Address: PERMAN & GREEN, 425 POST ROAD, FAIRFIELD, CT, 06824, US

(21) Appl. No.: 10/918,824

(22) Filed: Aug. 13, 2004

(30) Foreign Application Priority Data
Aug. 20, 2003 (GB) 0319488.3

(51) Int. Cl. G06F 12/08

(52) U.S. Cl. 711/170; 711/203

(57) ABSTRACT

An arrangement of a master device and a slave device, includes one or more physical memory means and a plurality of logical memory means, wherein one or more of the logical memory means are permanently accessible by the master device and one or more further logical memory means may be accessed by the master device in response to a pre-determined access code being received at a pre-determined memory location.

This invention relates to a serial interface, and in particular to two wire serial interfaces used to provide communications between electronic devices.

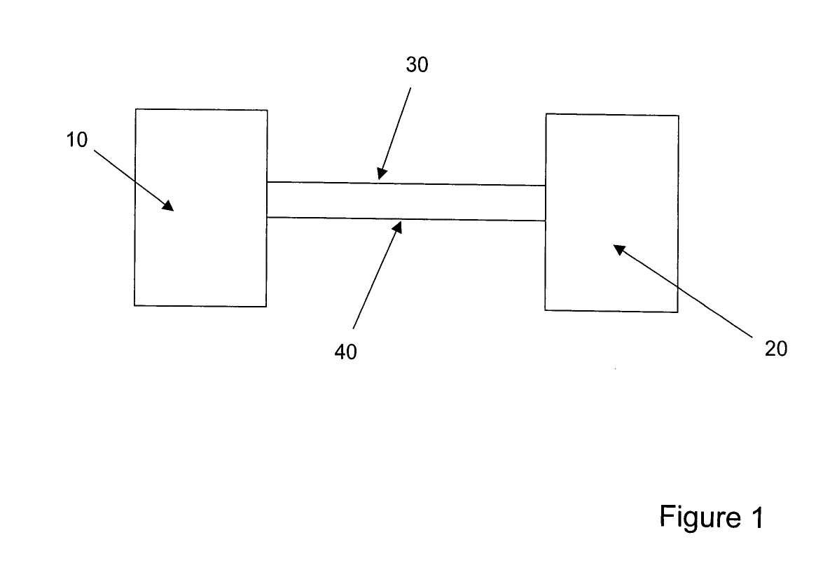

Typically, and with reference to FIG. 1, one of the devices is designated as ‘master’ 10 and the other device or devices are designated as a ‘slave’ 20, which respond appropriately to all requests made to them from the master device. In conventional two-wire systems one of the wires 30 carries a clock signal and the other wire 40 carries data. The master device may carry out both read and write operations; in read operations a slave device will report data stored in a memory location within the slave device and in write operations the master device can update data stored within the slave device in order, for example, to alter the operation of the slave device.

In order to support compatibility and inter-operability between devices made by different manufacturers, industry standards have been developed and agreed. In the field of transceivers for datacommunications and telecommunications, agreed standards include SFF-8472 (Digital Diagnostic Monitoring Interface for Optical Transceivers, rev. 9.3, Aug. 1, 2002, published by the SFF Committee, http://www.sffcommittee.com/) which allows an extended feature set to be defined, SFF-8074i (also referred to as INF-8074I, Small Form-factor Pluggable (SFP) Transceiver MultiSource Agreement (MSA), rev. 1.0, Sep. 14, 2000, published by the SFF Committee) which defines a serial identification interface and SFF-8053 (GBIC (Gigabit Interface Converter), rev. 5.5, Sep. 27, 2000, published by the SFF Committee).

Typically in such schemes, the master device will initiate communication with a slave device by transmitting an 8-bit signal; the first seven bits of the signal correspond to the address of the slave device and the final bit indicates whether a read or a write operation is required of the device (conventionally, a read operation is denoted by a ‘1’ and a write operation is denoted by a ‘0’). Once the communication with the slave device has been established and a second 8 bit signal is sent to specify the memory location to which the read/write operation applies. If a read operation has been specified then the contents of the memory location are reported to the master device; if a write operation has been reported then a further 8 bit signal is sent to be slave device and written to the specified memory location. An inherent limitation of this method is that each slave device contains 256 bytes of information and with a 7-bit address space the maximum number of slave devices is 128. In practice, parts of the address space are reserved so that only 112 slave may be addressed. This limits the total addressable memory to 28,672 bytes.

The limits to the memory capacity of each slave device and the limit to the memory addressable by a master device pose significant issues. It may be possible to use a plurality of logical device addresses to refer to different memory areas of a single physical device but his can cause additional problems, as many controllers cannot address more than one logical device at the same time. Another known problem is that the implementation of the separation of read/write memory areas and read only memory areas within a single logical device can be difficult, as many devices only allow one type of memory area within a single logical device.

A number of solutions that address these problems have been proposed. In one, a specific request is sent to a reserved logical device address that causes the slave device to toggle between memory areas that are to be addressed (this is implemented within SFF-8472 as the Address Change function). This method is not generally supported and is error-prone and slower than conventional logic addressing. Another approach is to attach one or more memory devices (either physical memory or logical memory devices) to the serial interface bus. Whilst it is not possible for the slave device to write directly to an individual memory device without preventing the master from reading data from that memory device (although this may be achieved by adding dedicated serial bus connections for each of the memory devices), it is possible for the master device to write data to all of the memory devices, with the slave device storing a master copy of the data so that any data that is incorrectly overwritten can be corrected before a subsequent read operation.

Another known technique (which is applicable in the case that the slave device is some form of micro-controller) is to not connect the serial interface of the micro-controller but to connect the clock and data lines to two general-purpose digital input/output lines of the micro-controller. The inputs of the clock and data lines can be interpreted by the software and/or firmware of the micro-controller, which enables multiple logical devices to be addressed, and to a greater extent than is possible with the Address Call function, or other similar functions. The main disadvantage of such an approach is that a significant amount of processor time is used in the implementation of the method.

According to a first aspect of the invention there is provided a master slave arrangement for providing communication between a master device and a slave device, the arrangement comprising one or more physical memory means and a plurality of logical memory means, wherein one or more of the plurality of logical memory means are permanently accessible by the master device, characterised in that one or more further logical memory means may be accessed by the master device in response to a first pre-determined access code being received at a first pre-determined memory location.

Furthermore, the master device may be prevented from accessing the one or more further logical memory means in response to a second pre-determined access code being received at a second pre-determined memory location and the master device is allowed to access the one or more further logical memory means in response to a third pre-determined access code being received at a third pre-determined memory location.

The contents of the one or more logical memory means permanently accessible to the master device may be used to determine the operation of a further apparatus that is in communication with the master slave arrangement, and the further apparatus may comprise a communications device. The operation of the further apparatus may be varied by altering the contents of one or more of the further logical memory means. One of the further logical memory means may be reserved for use by the manufacturer of the arrangement and/or one of the further logical memory means may be reserved for use by a user of the arrangement.

An embodiment of the invention will now be described by way of illustration only and with respect to the accompanying drawings, in which

FIG. 1 shows a schematic depiction of a first known master-slave arrangement;

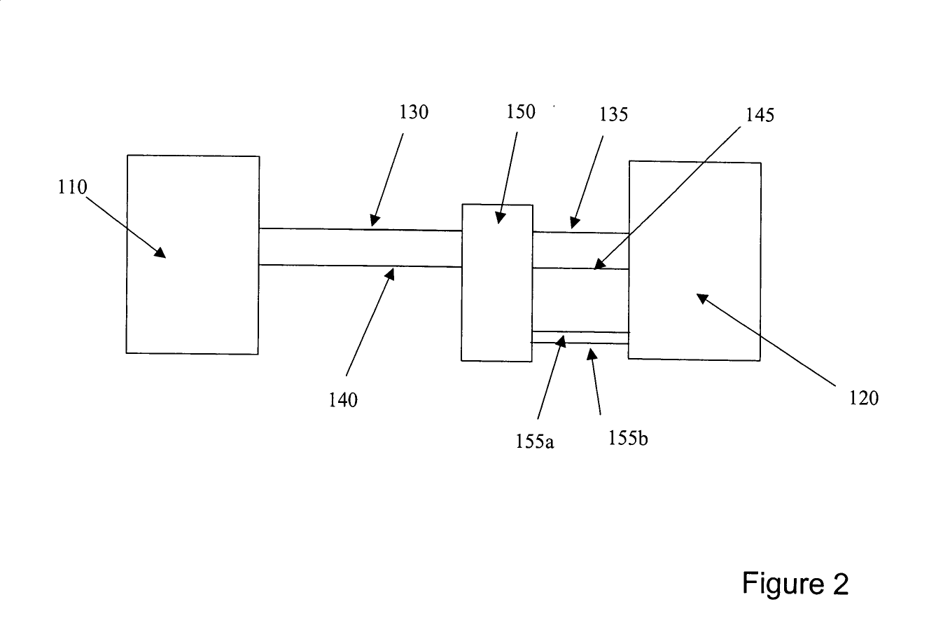

FIG. 2 shows a schematic depiction of a second known master-slave arrangement;

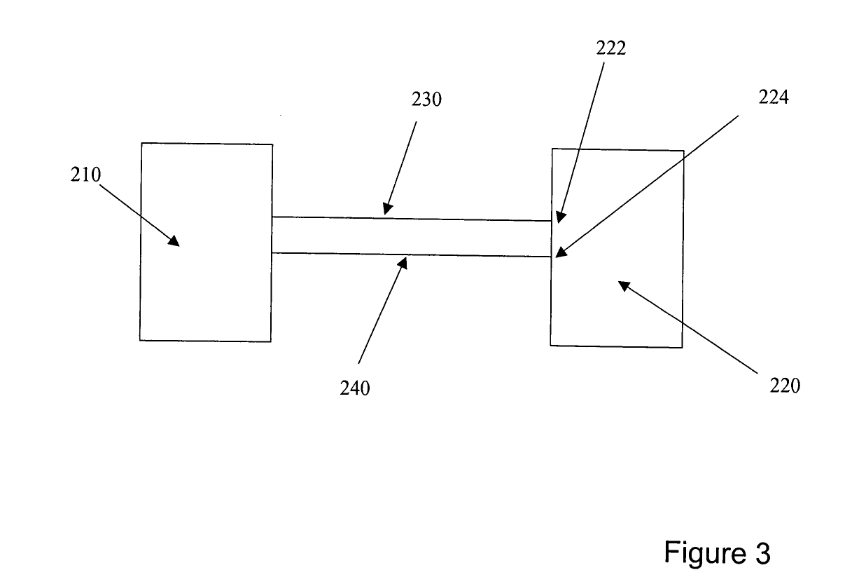

FIG. 3 shows a schematic depiction of a third known master-slave arrangement;

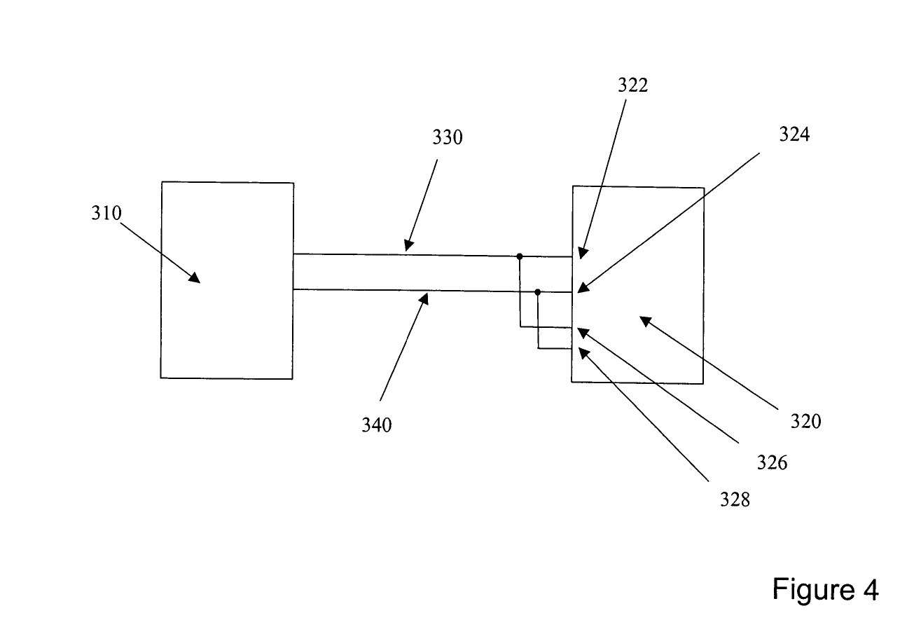

FIG. 4 shows a schematic depiction of a fourth known master-slave arrangement; and

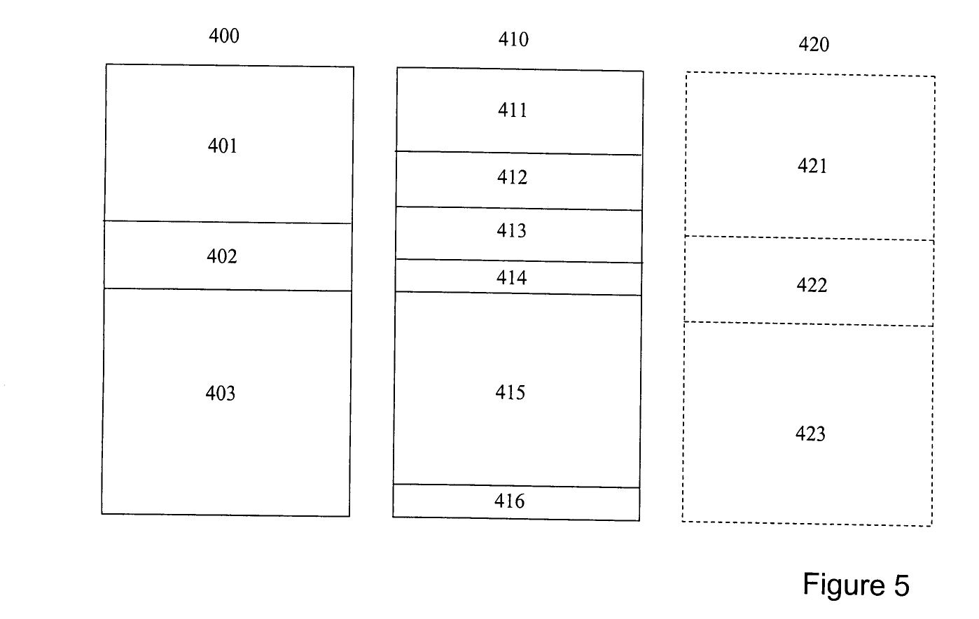

FIG. 5 shows a schematic depiction of a memory map.

FIG. 2 shows a schematic depiction of a known master-slave arrangement in which the master device 110 is in communication with a pre-processor 150, with data being communicated between the master and the pre-processor using first serial clock 130 and data 140 lines and between the pre-processor and the slave device 120 via second serial clock 135 and data 145 lines. There is additionally provided one or more addressing lines 155, which are connected between the pre-processor and the slave device. The master device 110 communicates with the pre-processor 150, which decodes and interprets the memory location requested by the master device to recognise a request addressed to more than one logical device address, before sending the request to the IC corresponding to the requested logical addresses.

FIG. 3 shows a schematic depiction of a further known master-slave arrangement in which master device 210 is connected to slave device 220 via serial clock line 230 and data line 240. The slave device 220 comprises a microcontroller that monitors one or more I/O lines and initiates an interrupt request in response to a particular state, or state sequence, at one of the monitored I/O lines. The interrupt causes the operations of the microcontroller to be halted and an interrupt-handling routine to be started.

FIG. 4 shows a schematic depiction of an alternative version of the arrangement shown in FIG. 3. As described above, the master device 310 is connected to a slave device 320 via serial clock line 330 and serial data line 340 with the serial clock line 330 connected to first I/O line 322 and the serial data line 340 connected to second I/O line 324. The I/O lines 322, 324 are general-purpose I/O lines accessible by the microcontroller, and preferably interrupt driven I/O lines. Additionally, the serial data and clock lines are connected to the data line and clock line connections 326 and 328 respectively, of a dedicated hardware interface. Now the slave device is only issued with an interrupt when a start or stop condition is detected by the hardware interface connections 326, 328.

FIG. 5 shows a schematic depiction of the memory map for a device complying with the SFF-8472 specification (ibid) Memory map 400 is the map for address A0h and memory map 410 is the map for address A2h. The contents of memory map 400 and memory map 410 are given below in Tables 1 and 2 respectively:

TABLE 1

| Reference Numeral | Byte range | Content |
|---|---|---|
| 401 | 0-95 | Serial ID defined by SFP MSA |
| 402 | 96-127 | Vendor Specific |
| 403 | 128-255 | Reserved in SFP MSA |

TABLE 2

| Reference Numeral | Byte range | Content |
|---|---|---|
| 411 | 0-55 | Alarm and Warning Thresholds |
| 412 | 56-95 | Calibration Constants |
| 413 | 96-119 | Real Time Diagnostic Interface |
| 414 | 120-127 | Vendor Specific |
| 415 | 128-247 | User Writable EEPROM |
| 416 | 248-255 | Vendor Specific |

One of the disadvantages of the memory maps as defined in the SFF-8472 specification is that the only areas that may be written to are the User Writable EEPROM region 415 and two bytes in the Real Time Diagnostic Interface 413 region. Thus there is limited operation for operators to modify the operation or behaviour of devices or for manufacturers to supply such functionality to their customers.

FIG. 5 shows a schematic depiction of a further memory map 420 for memory address A4h. Memory map 420 comprises regions 421, 422 and 423 which may be configured to provide further optional functionality, for example, customer-modifiable features such as modifiable alarm and warning thresholds for device operating parameters, or optional adjustment of device operating conditions or modes of operation may be useful in customising equipment to suit particular purposes.

For example, in optical transceivers, it may be possible to select from multiple data rates or to adjust the data rate in fine steps, allowing the transceiver performance (for example receiver bandwidth filtering) to be controlled by an operator. Furthermore, in transceivers in which clock and data recovery (CDR) is implemented, the approximate data rate must be known, so that the phase-locked loop (PLL) (usually a divider circuit) may be tuned to regenerate the correct clock frequency.

It is advantageous if the additional memory address 420 can be provided whilst still providing devices that are compliant with MultiSource Agreements such as SFF-8472, or other specifications. As is shown in FIG. 5, the SFF-8472 specification provides vendor specific memory areas (regions 414 & 416 at memory address A2h). These vendor specific memory areas may be configured such that if the master device writes a predetermined value to a predefined memory location (or locations) within the vendor specific memory areas, one of more further memory addresses may be activated, allowing the firmware-implemented serial interface to respond to requests addressed to an additional logical device address (for example, A4h=10100100 binary=164 decimal) where the additional features could be implemented. In this way, a product could work in exactly the same way as a standard SFF-8472 MSA-compliant product, but could provide an Extended Extended Feature Set (E²FS) to customers who choose to enable them without causing any interference to customers who do not.

It would also be possible to prevent addressing incompatibilities by allowing users to set the logical device address at which they wish to access the E²FS features. It is envisaged that the default address would be A4h, as is described above, but the address could be set to take any legal value. Illegal values would include both the MSA-defined logical addresses for serial ID and Digital Diagnostic Monitoring (DDM) interface (addresses A0h and A2h respectively). In the event that either of these values are used, the E²FS would either be disabled to ensure there is no conflict, or it could be set to a default logical address such as A4h. Other illegal addresses include 00h, which is reserved for Address Change, all other addresses in the ranges 00h-0Eh and F0h-FEh and all odd numbers (i.e. where the least-significant bit is set to 1) because the LSB is reserved for read/write signalling (odd numbers could alternatively be rounded down to the next lower even number by setting the LSB to zero, then checking whether the new address is legal).

Similarly, a further memory address may be provided such that the manufacturer can provide an engineering mode, that when activated enables fundamental settings to be programmed, for example at time of manufacture. It is possible to protect this area to prevent inadvertent corruption of device parameters by requiring a password to be written in memory and/or to require a specific set of unusual conditions to be met before allowing access. For example, these could include specific voltages or waveforms on certain connections or, for an optical transceiver, a value in a particular range to be detected by the receiver optical power monitor. This vendor specific memory address may be provided in addition to or in place of an additional memory address provided for device operators/customers.

A code may be incorporated in the vendor-specific memory area that would enable the device to be switched between Address Change mode and dual-address mode if desired. This would allow the same device to be used in host systems that implement SFF-8472 by either of the allowed methods.

When operated in Address Change mode, it would be possible to disable the logical device address that is not being accessed, allowing the system to avoid conflicts that may occur with that address. A further option is to allow a flexible mode that supports both Address Change and dual-address modes by responding appropriately to address 00h Address Change commands while keeping addresses A0h and A2h enabled at all times.

If stored in non-volatile memory, various customisations and mode selections need only be set once (for example in the factory) and can be retained even when the system power supply is disconnected or turned off. Likewise, if the device is removed from the system power supply (e.g. if the device is a hot-pluggable fibre-optic transceiver), it will retain the customised characteristics, allowing it to be used in a system that is not programmed to change the customisable features.

Such semi-permanent reconfiguration may be particularly desirable in choosing whether to implement Address Change mode, or setting a specific logical device address for certain feature (e.g. changing the device addresses for serial ID, SFF-8472 features or E²FS features). Changing of certain device addresses, such as serial ID, might be necessary in certain rare cases of address conflict on a specific system design. Alteration of the logical device addresses may cause non-compliance to-a specific MSA, and it may be desirable to implement a flag signal or a memory flag that is indicative of such non-compliance or possible non-compliance.

Although the foregoing discussion has been specific to devices compliant with SFF-8472, it is to be understood that the present invention may be extended to two-wire serial interfaces that are compliant with other specifications.

1. A master slave arrangement for providing communication between a master device and a slave device, the arrangement comprising one or more physical memory means and a plurality of logical memory means, wherein one or more of the plurality of logical memory means are permanently accessible by the master device, characterised in that one or more further logical memory means may be accessed by the master device in response to a first pre-determined access code being received at a first pre-determined memory location.

2. A master slave arrangement according to claim 1, wherein the master device is prevented from accessing the one or more further logical memory means in response to a second pre-determined access code being received at a second pre-determined memory location.

3. A master slave arrangement according to claim 2, wherein the master device is allowed to access the one or more further logical memory means in response to a third pre-determined access code being received at a third pre-determined memory location.

4. A master slave arrangement according to claim 1, wherein the contents of the one or more logical memory means permanently accessible to the master device are used to determine the operation of a further apparatus that is in communication with the master slave arrangement.

5. A master slave arrangement according to claim 4, wherein the further apparatus comprises a communications device.

6. A master slave arrangement according to claim 4, wherein the operation of the further apparatus can be varied by altering the contents of one or more of the further logical memory means.

7. A master slave arrangement according to claim 1, wherein one of the further logical memory means is reserved for use by the manufacturer of the arrangement.

8. A master slave arrangement according to claim 1, wherein one of the further logical memory means is reserved for use by a user of the arrangement.
